(19) United States
(12) Patent Application Publication
(10) Pub. No.: US 2008/0120712 A1
(43) Pub. Date: May 22, 2008

(54) METHOD AND SYSTEM FOR REMOTE SECURITY TOKEN EXTENSION

(75) Inventor: Thomas Ayers, Lovettsville, VA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: TELOS CORPORATION, Ashburn, VA (US)

(21) Appl. No.: 11/943,318

(22) Filed: Nov. 20, 2007

Related U.S. Application Data
(60) Provisional application No. 60/866,619, filed on Nov. 21, 2006.

(51) Int. Cl. H04L 9/32

(52) U.S. Cl. 726/9

(57) ABSTRACT

A method and system for extending the range of a security token allow a system to have a security token be utilized remotely from the system that will receive information and signals from that security token. A remote token extender can interface with a security token (such as an identity (or ID) token), configure the signals and information associated with that security token into a format for transmission across a selected media (such as a network), and transmit those signals and information across that media. At the receiving end, a local token extender can reconstitute those signals and information for use by a complementary device (such as an ID card reader) at the local system.

### BACKGROUND

1. Field

The present invention relates generally to the field of authentication and information security, and more specifically to authentication to physical and logical resources using remote extension of security tokens, including identification (ID) tokens.

2. Background

Most security tokens today require physical contact or close proximity to the system or device for the security token to be used. This includes such things as: smart cards, which must be inserted into a smart card reader; proximity cards, which must be presented to a proximity card reader; hardware dongles, which must be attached to a port on a computer; and other similar devices that rely on a physical security token. These security tokens can be used for various purposes, including allowing access to sensitive resources, providing physical access to protected spaces, or allowing usage of protected data and programs.

Often, the physical proximity required by these tokens is not always possible or desirable. There can be any number of applications where a particular resource or physical space must be accessed in such a way that a physical security token and the associated reader are not co-located. This could include, for example, a person needing access to a physical space, computer resource, or data and the security token is not available at the required location. Another example could be a person needing access but for convenience they would like to extend the ID token. For example, in a physical security application the security token to open a vehicular gate may be out of reach from the inside of a vehicle. Additionally the standard security token available to the driver may be different than the token reader to be used for opening the vehicular gate. Thus, a need exists for extending the range of usable access provided by a security token and a remotely located reader. Further, a need exists for allowing a security token of one type to be used with a remotely located reader of another type.

### SUMMARY

The present invention includes a system for extending the range of a security token, including an identification token that could contain a certificate. The token extender allows the use of access tokens at a distance greater then normally supported by the token. The system has an extender at the remote location with the normal interface for the token connected to it. At the location the token would be used the token extender communicates with the remote token extender and provides the local interface the information as if the security token was presented locally.

### BRIEF DESCRIPTION OF THE DRAWINGS

FIG. 1 is an example of a number of different security token systems according to the prior art.

FIG. 2 illustrates an example of a security token extender that operates over a serial interface.

FIG. 3 illustrates an example of a security token extender that could be used with a proximity token in a physical access application.

FIG. 4 illustrates an alternative example of a security token extender that could be used with a proximity token.

FIG. 5 illustrates an example of a security token extender that could be used with a smart card in a database access control application.

FIG. 6 is a block diagram that illustrates an example architecture for a generic security token extender.

FIG. 7 is a block diagram that illustrates an example architecture for a security token extender for use in a serial port application.

FIG. 8 is a block diagram that illustrates an example architecture for a universal security token extender.

### DETAILED DESCRIPTION

A security token can be any type of device used to provide or enhance security over electronic information by being a required part of authenticating to the system. An example of a security token could be a hardware security dongle or a smart card. A security token can also be used as an identification (or “ID”) token, where the token contains information about its holder's identity, thereby allowing the holder of the ID token to authenticate to a particular system. For example, in a public key infrastructure (PKI) involving a public key and private key (i.e., a “key pair”), the user may share the public key of the user's key pair through a mechanism known as a digital certificate (or simply a “certificate”). In addition to the public key, a certificate can contain a number of other fields that hold information about the user or about the certification authority (CA) that issued the certificate. The well understood X.509 standard, ITU recommendation ITU-T X.509, defines a certificate format commonly used for Internet communications. An ID token could be configured to securely hold the private key, while also holding the public key but allowing the public key to be easily distributed.

As is well known, a security token comprises one factor of multi-factor authentication, where the security token comprises “something you have” (while a password or some other shared secret comprises “something you know” and a biometric comprises “something you are”). Incorporation of two factors is an important part of many security regimes.

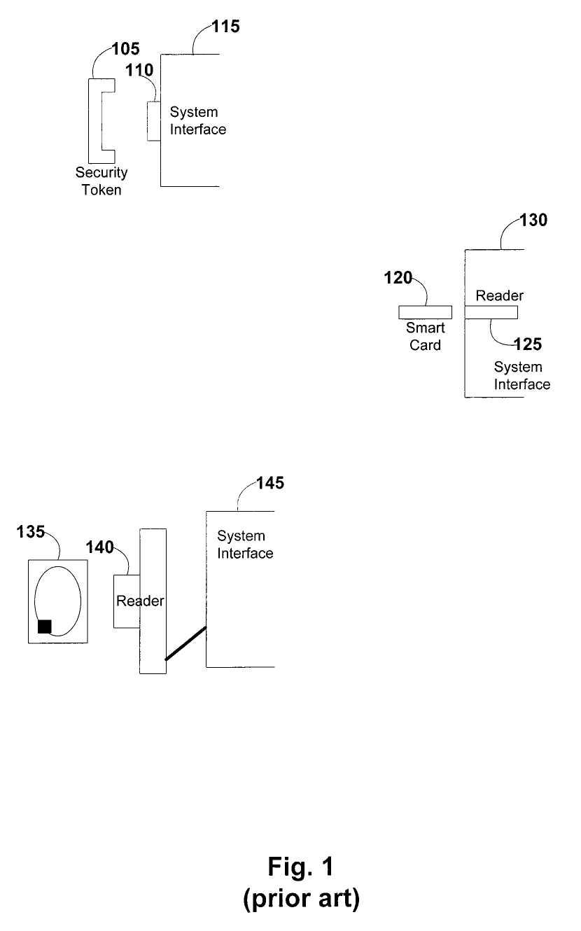

The use of a security token often requires a device to read that security token. An exemplary system is shown in FIG. 1 of a system according to the prior art. As shown in FIG. 1, a security token can be either inserted into a reader (e.g., smart card 120 being inserted into smart card reader 125 at system interface 130) or presented to the reader (e.g., “proximity” card or prox card 135 that is brought within a certain distance of reader 140 connected to system interface 145.) A security token could also include a serial port security token (or “dongle”) that connects to serial port 110 that is a part of system interface 115. It must be noted that the word “exemplary” is used exclusively herein to mean “serving as an example, instance, or illustration.” Also, any embodiment described herein as “exemplary” is not necessarily to be construed as preferred or advantageous over other embodiments.

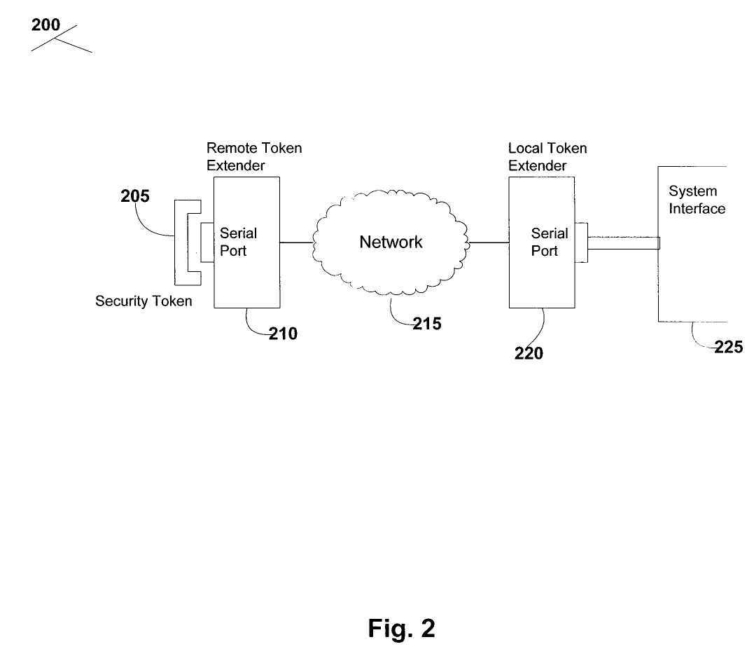

As shown in FIG. 2, a token extender can be an electronically-implemented system for extending the range of security tokens beyond their intended range of operation, in a manner that preserves the integrity of the security token (including, for example, token format and resident data). A token extender, which can comprise a remote token extender 210 and a local token extender 220, can operate independently from the physical access limits of security token 205. In doing so, the use of a token extender can extend the electrical characteristics any type of compatible security token across any type of transmission media. Thus, the token extender can enable remote access to physical and/or logical resources. This can extend the overall physical distance and logical range of the security token, which can allow the user the freedom to present the security token at any place the user can make a connection from the remote token extender to the local token extender.

In an embodiment, a token extender can be inserted at various points in the path used for reading a security token. At the point in the path into which the token extender is inserted, remote token extender 210 can take the information presented from security token 205 and package it appropriately for transmission to local token extender 220. For example, remote token extender could package the information from security token 205 in a form appropriate for transmission over a network such as the well known transmission control protocol (TCP) or Internet protocol (IP). Local token extender 220 can then present the information to system interface 225 at the receiving system of interest. This can be done in a bidirectional manner, which requires sufficient knowledge of the information and interface to properly configure the extender to correctly capture the information to be extended.

As shown in FIG. 2, a system according to the present invention can consist of at least two components—a local token extender and a remote token extender, both of which can be connected via a transmission medium (such as network 215). As discussed above, a remote token extender can receive the information read from the security token, transform that information into the form needed for securely transmitting the information over a transmission medium, and transmit the transformed information to a remote system. A local token extender can receive information from a transmission medium that has been sent by a remote token extender, unpackage that information for use by the system of interest, and transmit the unpackaged information through the local security extender to the system interface.

FIG. 2 illustrates an example of a token extender being used with a physical security token that can be connected to a serial port of a computer (i.e., a dongle). In typical operation, the security token is inserted into system serial interface to gain access to a protected system or resource. The system may then interact with the token establishing the access level to be granted.

Via the use of the token extender shown in FIG. 2, local token extender 220 can be connected to the serial port of the computer or system for which access is being protected. At the remote location, remote token extender 210 can be used to interface with security token 205. Local token extender 220 and remote token extender 210 can communicate over the transmission medium (e.g., network 215), causing local system interface 225 to perceive the token as having been connected locally instead of remotely.

Since remote token extender 210 and local token extender 220 are repeating the signals at each respective interface, even non-standard protocols that may not comply with standards used in certain security models can still be operated correctly. For example, a tailored serial interface protocol could be used where CTS is set true and then set false twice by local system interface 225 and a response of RTS could be toggled three times by security token 205. Data could then be sent with both signals false. In such a case of a proprietary or tailored serial interface protocol, remote token extender 210 and local token extender 220 would simply repeat the information presented. Similarly, the use of remote token extender 210 and local token extender 220 can allow security tokens having one type of interface (e.g., a smart card) to be used with a system having a different interface type (e.g., a serial port interface or proximity card interface).

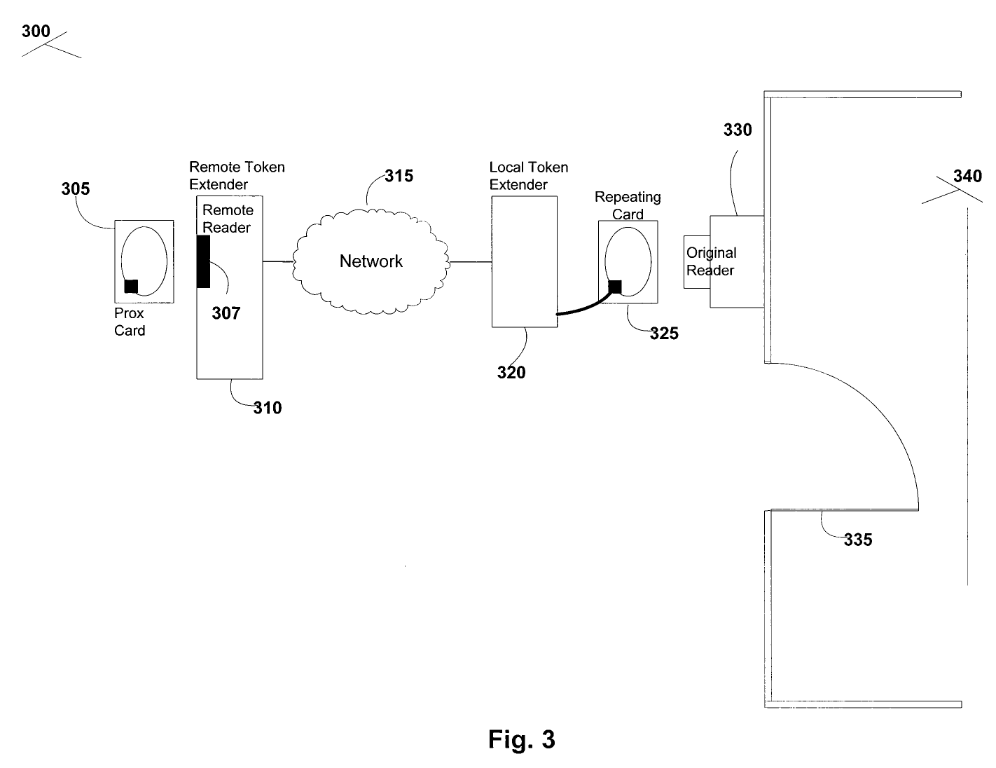

FIG. 3 illustrates an example of a token extender being used with proximity token 305 (more commonly known as a proximity card) and proximity reader 330 in an application that will allow physical access to protected space 340. In typical operation and as is well known, a proximity reader transmits a radio frequency (RF) signal that activates the proximity card and causes it to respond with its information. That information can then be used by the system interface to provide access to a protected system or resource.

Through the use of the token extender shown in system 300 shown in FIG. 3, local token extender 320 can be connected to repeating proximity card 325. At the remote location, remote token extender 310 can be used to interface with proximity card 305 via remote reader 307. Local token extender 320 and remote token extender 310 can communicate over the transmission medium (e.g., network 315), causing original reader 330 to perceive that proximity card 305 has been presented within the field of original reader 330. In the physical access example shown in FIG. 3, this could allow door 335 to be unlocked allowing physical access to protected space 340. In actuality, the information from proximity card 305 read by remote reader 307 (which can be a component of remote token extender 310) can be transmitted over network 315 to local token extender 320. Local token extender 320 can then relay that information and signals through repeating card 325 to original reader 330. This would then appear as if proximity card 305 had been presented within the field of original reader 330.

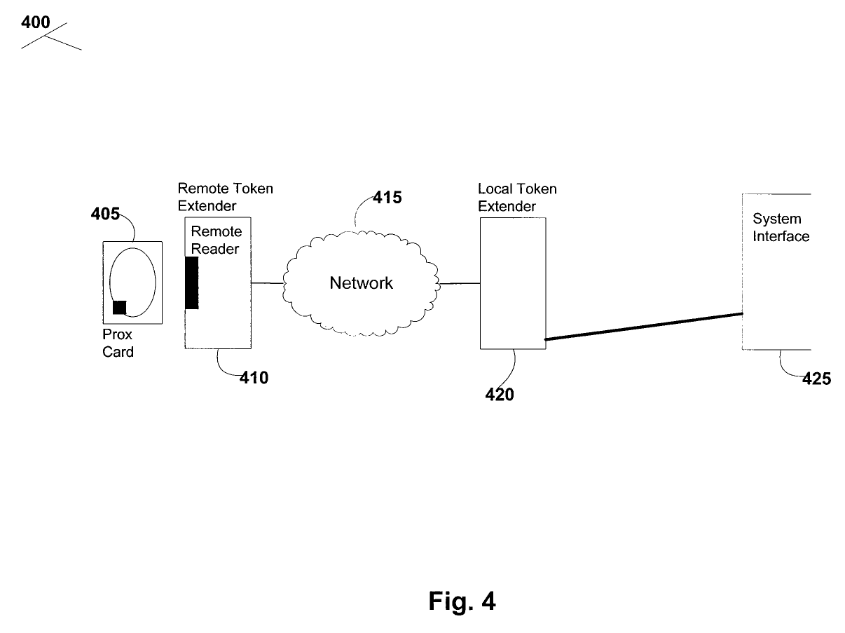

In an alternative embodiment involving proximity cards shown in FIG. 4, a proximity card reader could be integrated within remote token extender 410 (as was also shown in FIG. 3), while at the other end local token extender 420 could be directly connected to system interface 425. In this scenario, a proximity card reader would not be needed to interface with system interface 425. Thus, proximity card 405 could be presented near remote token reader 410, and resulting information read from proximity card 405 and the associated signals could be packaged by remote token reader 410 for transmission across network 415 to local token extender 420. That information and those signals could then be reconstituted by local token extender 420 for direct provision to system interface 425.

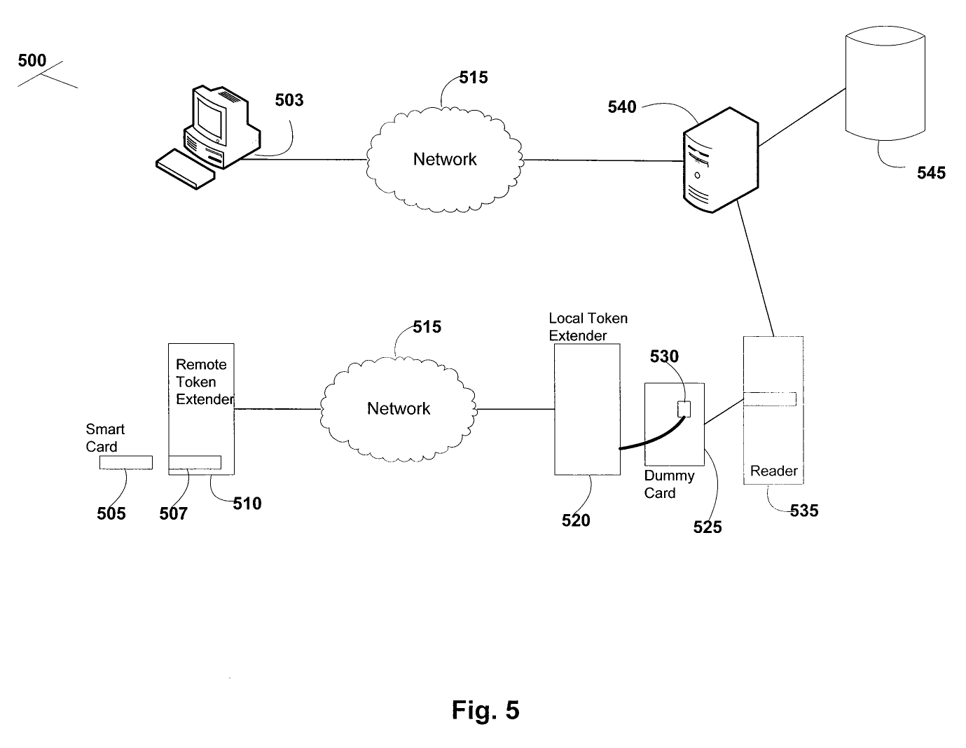

FIG. 5 depicts another scenario that could benefit from the use of a token extender. Applications that integrate smart card technology could utilize a remote token extender 510 that contains a smart card reader 507 to read information and generate representations of signals associated with the reading of smart card 505. Local token extender 520 and remote token extender 510 can communicate over the transmission medium (e.g., network 515), causing smart card reader 535 to perceive that smart card 505 was inserted into and read by local smart card reader 535. This could be used in an access control application (restricting data access to a specific computer) to allow a remote user to present the token at computer 540. Using computer 503 the user could remotely control computer 540 to access the needed data. In actuality, the information from smart card 505 read by remote reader 507 (which can be a component of remote token extender 510) can be transmitted over network 515 to local token extender 520. Local token extender 520 can then relay that information and those signals through contact pins 530 contained within dummy smart card 525 to local smart card reader 535. This would then allow access control decisions to be made by server 540 based on information from smart card 505 that would appear to have been inserted into and read by local smart card reader 535. In the event that the user presenting card 505 (and any associated shared secret information, such as a personal identification number (PIN)) is allowed to access database 545, that access can be facilitated remotely via remote token extender 510 and local token extender 520.

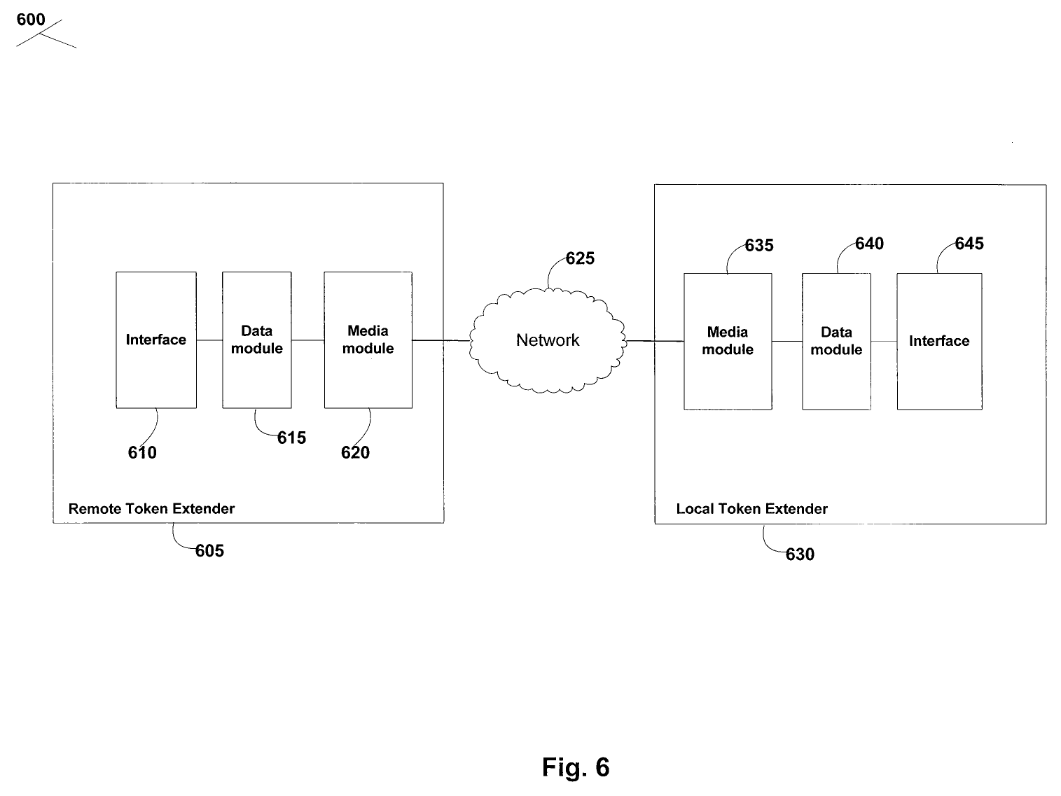

FIG. 6 depicts a generic token extender architecture, though it must be noted that the internal architecture can vary depending on a number of factors. Some factors would include the type of token, the type of media between the local and remote extenders, and factors such as cost, size, power requirements, etc.

In an embodiment, a token extender could consist of a remote token extender 605 and a local token extender 630. Remote token extender could contain interface module 610, data module 615, and media module 620. Similarly, local token extender could contain interface module 635, data module 640, and media module 645.

In the above example, remote interface module 610 could contain logic to interface to the token and local interface module 635 could contain logic to interface to the local reader. Remote data module 615 and local data module 640 would collect the data from the respective interface module and package it for transmission using the associated media module (remote media module 620 in the case of remote token extender 605 and local media module 635 in the case of local token extender 630. Each media module would contain the logic for handling the media interface and associated data management. The media module could comprise a pair of wires between the local and remote extenders to managing a routable protocol (such as the well understood TCP/IP).

The generic architecture in FIG. 6 could be applied to an example situation involving the use of a serial token. In this example, remote token extender interface module 610 could contain a standard RS-232 interface into which a security token (i.e., dongle) would be inserted. Local token extender interface module 645 would be connected to the serial port of the target system computer. As is well know, the RS-232 protocol has one transmit data line and one receive data line along with a number of control lines. Remote token extender interface module 610 would receive the incoming RS-232 data and control signals, and convert them to appropriate data levels for remote data module 615. In an embodiment, transistor-transistor logic (TTL) data levels could be utilized. Remote data module 615 could time sample each of the different interface lines. The received data would be sent to remote media module 620 and transmitted over the media (e.g., network 625) to local token extender 630. In an embodiment, remote media module 620 could be a set of RS-422 drivers. The data received at local media module 635 would be processed and sent to local data module 640. Local data module 640 would then set each of the control lines and data lines using the same time sampling as remote data module 615. Data from local data module 640 would then be sent to local interface module 645 to be converted back into RS-232 levels. In this way each change in the data line level or control line level would be relayed between the two interface modules.

In the above example discussion of a simple serial port approach using the generic architecture shown in FIG. 6, each data module is a simple time multiplexer. In an alternative embodiment, each data module 615 and 640 could use a standard Universal Asynchronous Receiver Transmitter (UART) chip.

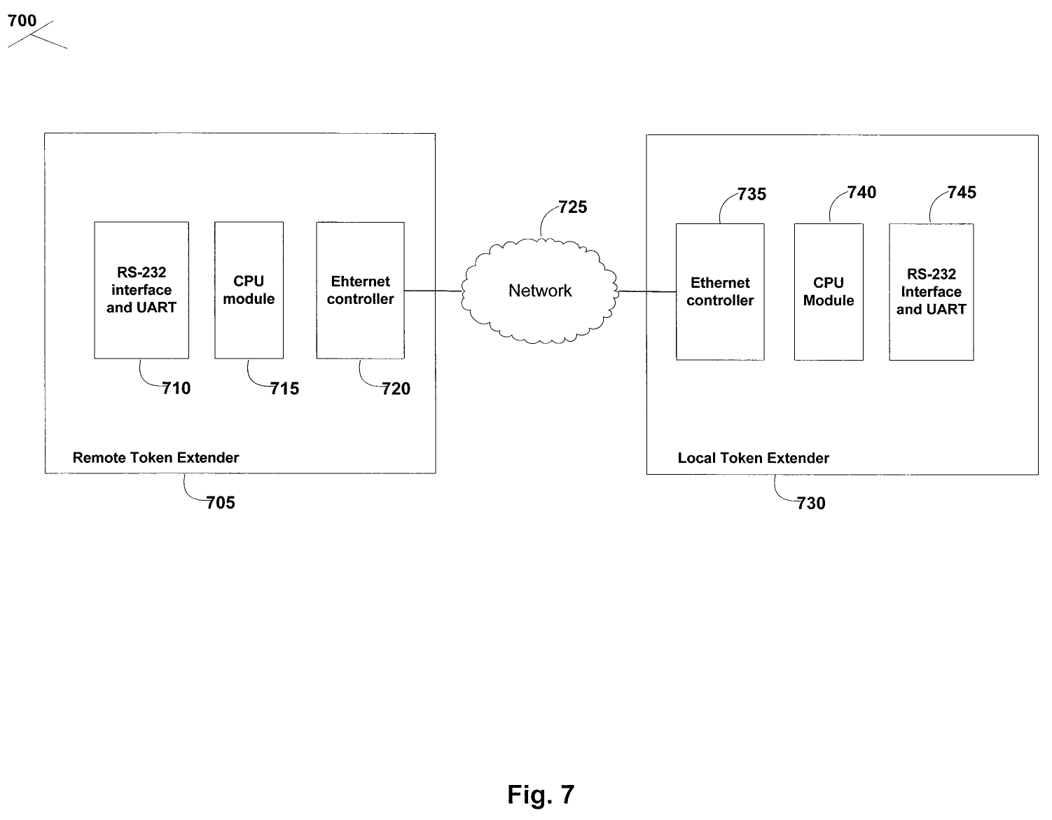

As shown in FIG. 7, remote UART chip 710 and local UART chip 745 could contain RS-232 interface logic as well. The data from remote UART chip 710 could be read by a simple CPU, shown as remote CPU module 715 in remote token extender 705. Local token extender could similarly contain local CPU module 740. Remote CPU module 715 and local CPU module 740 would then communicate by each using a media module, shown as remote Ethernet controller 720 in remote token extender 705 and local Ethernet controller 735 in local token extender 730. In general, a media module in this example could be a simple wire like the RS-422 approach described above in conjunction with FIG. 6 or using a TCP/IP stack over Ethernet (or other media).

In the example shown in FIG. 7, if remote token extender 705 and local token extender 730 are connected to the same Ethernet segment (i.e., non-routed and non-bridged), remote CPU module 715 and local CPU module 740 can function in a way very similar to that of the data module in the first example. Each CPU module would read the data from its respective UART module and assemble it into a packet, then send that data packet to the other token extender. At the receiving token extender, the packet would be decoded and written to the UART.

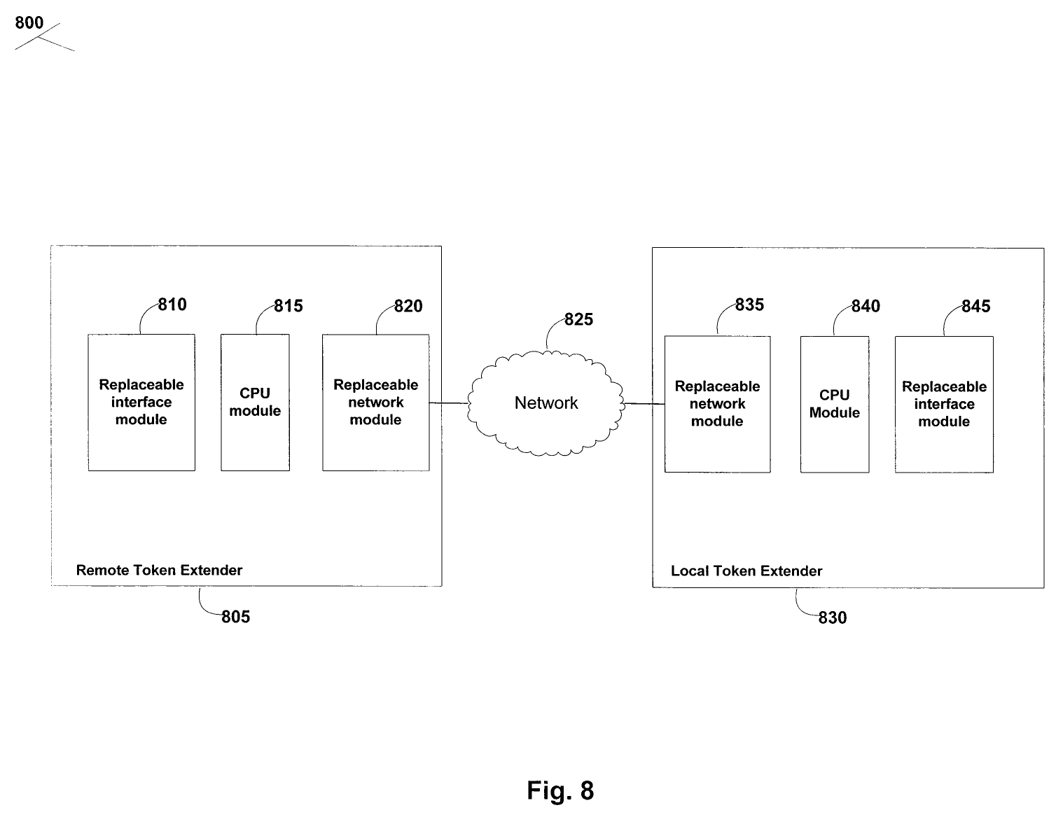

FIG. 8 depicts a universal token extender. A number of different security tokens (and, in particular, ID tokens) exist today. It is expected that additional types of tokens will continue to be developed. As this continues, it could result in an end user being responsible for a number of ID tokens with different interface types even if the same information could be stored on a single ID token.

A universal token extender could utilize one or more replaceable modules in both a remote token extender and a local token extender to accommodate different types of tokens, media, and interface types. Such an approach would allow for one token extender to be used with different tokens by simply changing an interface module.

In the example shown in FIG. 8, remote token extender 805 and local token extender 830 could each be fitted with interface modules for the particular token to be used in the applicable deployment. In an embodiment, universal token extender 805 and universal token extender 830 would need to go through a training process. Each universal token extender could be placed in close proximity to allow a direct high speed connection to be made between the two units (e.g., a direct insertion cable between replaceable network module 820 and replaceable network module 835). Each token extender 805 and 830 could then be placed into a learning mode. In this mode, CPU module 815 and CPU module 840 effectively connect replaceable interface module 810 and replaceable interface module 845 over the direct connect cable. This allows a high rate of data transfer between the two units.

With remote token extender 805 and local token extender 830 now directly connected, local token extender 830 can be connected to the local system and remote token extender 805 can have an ID token inserted into it. Each CPU module 815 and 840 can monitor the data exchange between the ID token and the local system to determine signals and pattern of data exchange. After a number of learning cycles each CPU module 815 and 840 can transition into a tuning mode. This mode can simulate the operation of the selected token over different network media, including, for example, a non-routed local area network (LAN), a routed LAN, a wide area network (WAN), a wireless LAN (WLAN), or a cellular network. In the event functional problems are found during either the learning mode or tuning mode, the system can provide configuration data and other data collections that can be analyzed. Once analyzed, modifications to the interface or configuration can be implemented to resolve the problem.

Using a universal token extender approach as described in the context of FIG. 8 can provide another useful feature of cross token compatibility. For example, a user may have an ID token that has been implemented using a USB interface and that contains a certificate (such as a certificate configured according to the well known X.509 standard). The user may, however, need to access a system that is configured with a RS-232 interface and that works with a custom designed token. In this case a universal token extender configured with an RS-232 interface for use at the local system and a remote unit configured with a USB interface could seamlessly present the certificate for the user from the USB token to the system utilizing the RS-232 interface.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various logical blocks and algorithm steps described herein may be implemented as hardware, software, or combinations of both. Whether such functionality is implemented as hardware or software depends upon the particular application and design constraints imposed on the overall system. The described functionality may be implement in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein.

Methods described in connection with the embodiments disclosed herein may be embodied directly in hardware, in a software module executed by a processor, or in a combination of the two. A software module could reside in any form of storage medium known in the art, including, without limitation, RAM, ROM, or flash memory, a CD-ROM, a removable disk, or. In the alternative, the storage medium may be integral to the processor. The processor and the storage medium may reside in an ASIC. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for extending the range of a security token comprising:
receiving a security token into a remote system;
extending one or more characteristics of the security token across a transmission media via a remote token extender;
receiving the characteristics at a local token extender coupled to a local system; and
securely enabling remote access to resources at the local system without revealing any information about a data format of the token.

2. A method as in claim 1 wherein the security token is an identity token.

3. A method as in claim 2 wherein the security token is a proximity card.

4. A method as in claim 2 wherein the security token is a smart card.

5. A method as in claim 1 wherein the security token is a dongle.

6. A method as in claim 1 wherein the characteristics further comprise signals.

7. A method as in claim 1 wherein the characteristics further comprise data.

8. A method as in claim 1 wherein the resources include information in a protected database.

9. A method as in claim 1 wherein the security token at the remote token extender contains an interface type different from a reader having a different interface type at the local token extender.

10. A system for extending the range of a security token comprising:
a remote token extender; and
a local token extender, wherein the remote token extender and the local token extender cause one or more characteristics of the security token to be extended across a transmission media.

11. A system as in claim 10, wherein the remote token extender comprises:
an interface module that receives data and signals from a security token located remotely from a local system;
a data module that converts the received data and signals into a form usable by a media module; and
a media module that packages the converted data and signals into a form appropriate for transmission across a particular media.

12. A system as in claim 11, wherein the interface module comprises a serial port.

13. A system as in claim 11, wherein the interface module comprises a universal asynchronous receiver transmitter (UART).

14. A system as in claim 10 wherein a security token at the remote token extender contains an interface type different from a reader with a different interface type at the local token extender.

15. A method for permitting physical access to a protected space at a remote location, comprising:
presenting a security token at a remote reader;
extending one or more characteristics of the security token across a transmission media via a remote token extender;
receiving the characteristics at a local token extender coupled to a local system containing access rights information for the protected space; and
securely enabling access by a user of the remote system to the protected space without revealing any information about a data format of the token.

16. A method as in claim 15 wherein the security token is an identity token.

17. A method as in claim 16 wherein the security token is a proximity card.

18. A method as in claim 16 wherein the security token is a smart card.

19. A method as in claim 15 wherein the characteristics further comprise signals.

20. A method as in claim 15 wherein the characteristics further comprise data.

21. A method as in claim 15 wherein the security token at the remote token extender contains an interface type different from a reader having a different interface type at the local token extender.
